(19) United States
(12) Patent Application Publication
(10) Pub. No.: US 2012/0008231 A1
(43) Pub. Date: Jan. 12, 2012

(54) MAGNETIC HEAD SLIDER AND MAGNETIC DISK UNIT USING SAME

(75) Inventors: RYUJI TSUCHIYAMA, Matsudo (JP); Atsuko OKAWA, Yokohama (JP); Daisuke SATO, Fujisawa (JP); Mitsuhiro HASHIMOTO, San Jose, CA (US)

(73) Assignee: Hitachi, Ltd.

(21) Appl. No.: 13/156,029

(22) Filed: Jun. 8, 2011

(30) Foreign Application Priority Data
Jul. 12, 2010 (JP) 2010-158003

(51) Int. Cl. G11B 5/02

(52) U.S. Cl. 360/59; G9B/5.026

(57) ABSTRACT

There is provided the magnetic head slider including a reader, a writer, and a heater. A contact surface coming into contact with a medium surface when power is applied to the heater, and a step surface formed on both sides of the contact surface, through the intermediary of a step part, are provided on respective surfaces of the upper shield layer, the lower shield layer, the lower magnetic pole, the shield layer, and the return pole, the respective surfaces being opposite to a disk. And the respective contact surfaces of the upper shield layer, the lower shield layer, the lower magnetic pole, the shield layer, and the return pole are configured so as to be substantially circular in shape, as a whole, thereby providing a cylindrical small pad on a surface of a magnetic head slider, opposite to the disk.

### CLAIM OF PRIORITY

The present invention claims priority from Japanese patent application JP 2010-158003 filed on Jul. 12, 2010, the content of which is hereby incorporated by reference into this application.

### BACKGROUND OF THE INVENTION

1. Field of the Invention

The present invention relates to a magnetic head slider, and a magnetic disk unit using the same, and in particular, to a magnetic head slider excellent in realization of higher recording density, and higher reliability, and a magnetic disk unit using the same.

2. Description of the Related Art

In the case of a conventional magnetic head slider of a magnetic disk unit, a heater (heating element) mounted in the vicinity of a read-write element is heated by applying power thereto, and an air bearing surface in the vicinity of the element is caused to protrude, thereby controlling a flying height at reader and writer. As for definition of the flying height at reader and writer, on the basis of a relational expression among an optically measured flying height at reader and writer, power applied to the heater at the time when a flying height is controlled (abbreviated to thermal flying control power), and variation in flying height, a touch down power at the time when the flying height at reader and writer is lowered, and the lowermost point of the slider is in contact with a medium surface is found, and subsequently, a flying height corresponding to the thermal flying control power at the time when pulled back from the touch down power is defined as a flying height at reader and writer “h pull”. Further, as to definition of Touch Down Height “TDH”, in the case of the flying height at reader and writer being lowered, the lowermost point of the slider comes into contact with a micro-waviness of magnetic layer when the lowermost point of the slider becomes smaller than a magnetic film micro-waviness of magnetic layer on the medium surface, having a wavelength of micro-waviness 100 μm, and a height of micro-waviness on the order of about 0.7 nm. Because the flying height of the slider is optically measured, and a flying height at the lowermost point means a flying height from an ideal plane without surface roughness, a maximum height of the micro-waviness from the ideal plane becomes the touch down height. The touch down height can be found by use of a contact detection means, such as an Acoustic-Emission sensor, and so forth, from a touch down flying height when the flying height at reader and writer is lowered, or a relational expression among the optically measured flying height at reader and writer, the thermal flying control power, and the flying height variation, and the touch down power.

The most important technical problem with a magnetic disk unit is to enhance an areal recording density. A method for enhancing the areal recording density is to enhance read/write performance of both a magnetic head and a magnetic disk medium, positioning accuracy, and performance for processing a read signal. Since magnetic field intensity, in particular, is inversely proportional to the square of magnetic spacing, the smaller the magnetic spacing is, the dramatically higher will be the areal recording density. The magnetic spacing can be expressed as the sum of thickness of magnetic head slider overcoat, the flying height “h pull” at reader and writer, the touch down height TDH, thickness of a lubricant, and thickness of disk overcoat, and a method for reducing the magnetic spacing is to decrease respective values of addends. As an approach to reduction in the magnetic spacing, there is available reduction in the touch down height. However, there exists a non-approachable region between an air bearing surface of curved surface protruded shape, in the vicinity of the read-write element, and a micro-waviness of magnetic layer of wavelength about 100 μm, and this non-approachable region has been a stumbling block for reduction in the touch down height. If the thickness of the magnetic head slider overcoat is rendered smaller, this will cause the read-write element to undergo corrosion.

In Japanese Patent Application Laid-Open Publication No. H03-296907, there has been disclosed a magnetic head wherein only track width portions of respective soft magnetic layers of a writer and a reader, making up the head, are left out on an air baring surface while other portions thereof are removed by etching so as to increase a distance from a medium, and at the same time, a track width processing is applied to a shield layer of the reader, as well, to thereby expose only a protruded portion thereof to the air baring surface. However, in the case of this conventional technology, it is intended to reduce a track width of a magnetic head, and width processing is not applied in the track direction, so that the non-approachable region exists between the air bearing surface in the vicinity of the read-write element, and the magnetic layer micro-waviness surface, and it is therefore impossible to reduce the magnetic spacing.

### SUMMARY OF THE INVENTION

With a conventional magnetic head slider, a non-approachable region exists between an air bearing surface of curved surface protruded shape, in the vicinity of the read-write element, and a magnetic layer micro-waviness surface of a wavelength about 100 μm, and the non-approachable region has been the stumbling block for reduction in the touch down height. Further, since a contact area is not limited, the contact area is increased in size, and it has been impossible to completely remove a slider overcoat at a small over-push flying height.

It is therefore an object of the invention to aim at realization of a higher recording density of a magnetic disk unit by reducing the magnetic spacing of the magnetic head slider. Another object of the invention is to provide a magnetic head slider capable of completely removing a slider overcoat at a small over-push flying height.

To that end, in accordance with one aspect of the invention, there is provided a magnetic head slider including a reader composed of an upper shield layer, a lower shield layer, and a reading element provided between the upper shield layer and the lower shield layer, a writer composed of a lower magnetic pole, a main magnetic pole, a shield layer, and a return pole, and a heater for generating heat when power is applied thereto, wherein a contact surface coming into contact with a medium surface when power is applied to the heater, and a step surface formed on both sides of the contact surface, through the intermediary of a step part, are provided on respective surfaces of the upper shield layer, the lower shield layer, the lower magnetic pole, the shield layer, and the return pole, the respective surfaces being opposite to a disk, and the respective contact surfaces of the upper shield layer, the lower shield layer, the lower magnetic pole, the shield layer, and the return pole are configured so as to be substantially circular in shape, as a whole, thereby providing a cylindrical small pad on a surface of a magnetic head slider, opposite to the disk.

With the magnetic head slider, the center of the cylindrical small pad may be caused to coincide with the center of a distance between the reading element and the main magnetic pole.

Further, with the magnetic head slider, a groove may be provided between the reader and the writer, in the cylindrical small pad.

Still further, with the magnetic head slider, hp may be in a range satisfying a condition of 0.7 nm≦hp≦3.0 nm where hp is a height of the cylindrical small pad.

Yet further, with the magnetic head slider, hd may be in a range satisfying a condition of 10 μm≦hd≦50 μm where hd is a diameter of the cylindrical small pad.

Further, with the magnetic head slider, a slider overcoat on a surface of the cylindrical small pad may be removed by applying power to the heater.

Still further, with the magnetic head slider, an etching depth due to etching applied in an ion beam etching system may be rendered smaller than a depth of a step part between the contact surface and the step surface.

Yet further, with the magnetic head slider, a magnetic disk unit wherein the magnetic head slider according to an aspect of the invention is mounted.

The invention provides in its another aspect a magnetic disk unit wherein any of the magnetic head sliders is mounted.

According to an aspect of the invention, the magnetic spacing of the magnetic head slider can be reduced to thereby realize a higher recording density of a magnetic head unit. Further, with an aspect of the invention, a protective overcoat on the surface of the magnetic head slider can be completely removed at a small over-push flying height. Still further, with an aspect of the invention, the touch down height can be reduced by geometrically miniaturizing an area of the air bearing surface of curved surface protruded shape, in the vicinity of the read-write element of the magnetic head slider.

### BRIEF DESCRIPTION OF THE DRAWINGS

FIG. 1A is a view showing a magnetic head slider according to a first embodiment of the invention;

FIG. 1B is a view showing a conventional magnetic head slider;

FIG. 2 is a three-dimensional assembly view showing a portion of the magnetic head slider according to the first embodiment of the invention, in the vicinity of a cylindrical small pad thereof;

FIG. 3A is a view showing a method for manufacturing the magnetic head slider according to the first embodiment of the invention;

FIG. 3B is another view showing a method for manufacturing the magnetic head slider according to the first embodiment of the invention;

FIG. 3C is a still another view showing a method for manufacturing the magnetic head slider according to the first embodiment of the invention;

FIG. 4A is a view showing a method for using the magnetic head slider according to the first embodiment of the invention;

FIG. 4B is another view showing a method for using the magnetic head slider according to the first embodiment of the invention;

FIG. 4C is still another view showing a method for using the magnetic head slider according to the first embodiment of the invention;

FIG. 4D is yet another view showing a method for using the magnetic head slider according to the first embodiment of the invention;

FIG. 5 is a view showing results of shape measurement on the magnetic head slider according to the first embodiment of the invention;

FIG. 6A is a view showing results of shape measurement on the cylindrical small pad in the case of the thermal flying control power being 0 mV;

FIG. 6B is a view showing results of the shape measurement on the cylindrical small pad in the case of the thermal flying control power being 20 mV;

FIG. 6C is a view showing results of the shape measurement on the cylindrical small pad in the case of the thermal flying control power being 30 mV;

FIG. 7A is a view showing results of measuring a thickness of worn slider overcoat after pushing the magnetic head slider according to the first embodiment of the invention under a load corresponding to a flying height 1 nm;

FIG. 7B is a view showing results of measuring a thickness of worn slider overcoat after pushing down the magnetic head slider according to the first embodiment of the invention under a load corresponding to a flying height 2 nm;

FIG. 8 is view showing a relationship between a over-push flying height and a thickness of worn slider overcoat;

FIG. 9A is view showing results of measuring a Signal/Noise after pushed down the magnetic head slider according to the first embodiment of the invention under the load corresponding to the flying height at 2 nm;

FIG. 9B is a view showing results of measuring a Signal/Noise after pushed the magnetic head slider according to the first embodiment of the invention under the load corresponding to the flying height at 1 nm;

FIG. 10 is a view showing the results of measuring the surface of the medium that is used at the time of measuring the Signal/Noise;

FIG. 11 is a view showing results of calculation on flying height variation over time, at trailing edge and leading edge of the cylindrical small pad, respectively, in relation to the over-push flying height of the magnetic head slider according to the first embodiment of the invention;

FIG. 12 is a view showing the results of measuring respective Signal/Noise in the case of the magnetic head slider according to the first embodiment of the invention, and in the case of the magnetic head slider according to the related art;

FIG. 13 is a schematic representation for depicting an effect of reduction in the touch down height of the cylindrical small pad of the magnetic head slider according to the first embodiment of the invention;

FIG. 14A is a plan view showing a magnetic disk unit using the embodiment of the magnetic head slider according to the invention; and

FIG. 14B is a side view showing the magnetic disk unit using the embodiment of the magnetic head slider according to the invention.

### DETAILED DESCRIPTION OF THE PREFERRED EMBODIMENTS

Embodiments of a magnetic head slider according to the invention are described hereinafter with reference to the accompanying drawings.

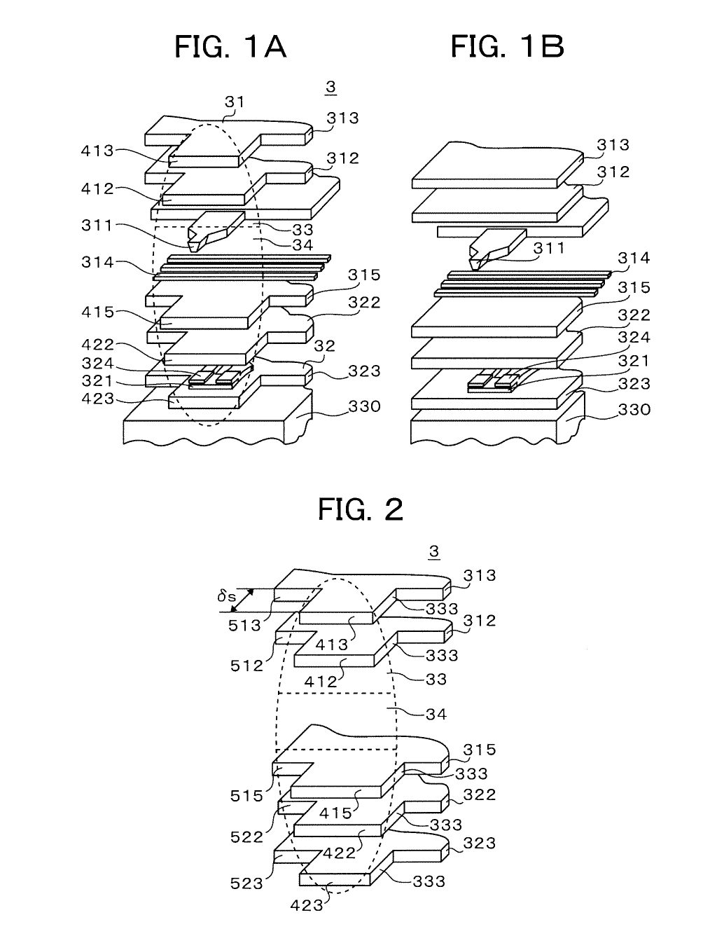

FIG. 1A is a view showing a magnetic head slider according to a first embodiment of the invention, in contrast to a conventional magnetic head slider shown in FIG. 1B.

First, FIG. 1B is a three-dimensional assembly view showing the conventional magnetic head slider according to the related art, and a magnetic head thereof includes a reader and a writer. The reader includes a substrate 330, an upper shield layer 322, a lower shield layer 323, a reading element 321 together with a electromagnetic pattern 324, provided between the upper shield layer 322 and the lower shield layer 323, while the writer comprises a lower magnetic pole 315, a main magnetic pole 311, a shield layer 312, an return pole 313, and a coil 314. With the conventional magnetic head slider, respective contact areas of layers, making up the reader and the writer, respectively, are not limited, so that the respective contact areas are increased in size.

FIG. 1A is a three-dimensional assembly view showing the magnetic head slider according to the first embodiment of the invention. A magnetic head according to the first embodiment of the invention, corresponding to the magnetic head 3 including the reader 32, and the writer 31, described with reference to FIG. 1B, has a contact surface, and a step surface formed on both sides thereof, through the intermediary of a step part, provided on respective surfaces of the upper shield layer 322, the lower shield layer 323, the lower magnetic pole 315, the shield layer 312, and the return pole 313, opposite to a disk. And when a flying height at reader and writer is lowered, or the disk is stopped, the respective contact surfaces 422, 423, 415, 412, 413 of the upper shield layer 322, the lower shield layer 323, the lower magnetic pole 315, the shield layer 312, and the return pole 313, as a whole, are rendered substantially circular in shape, and the respective surfaces of the upper shield layer 322, the lower shield layer 323, the lower magnetic pole 315, the shield layer 312, and the return pole 313, opposite to the disk, as a whole, make up a cylindrical small pad 33. Further, the magnetic head slider is provided with a heater (heating element) for generating heat when power is applied thereto, although not shown in the figure, and the flying height at reader and writer can be lowered by applying power to the heater. With the magnetic head slider according to the present embodiment, the contact areas of respective layers, making up the reader, 32 and the writer 31, respectively, are limited since the respective layers are provided with a step surface, so that the contact area of the contact surface is decreased in size.

Further, with the first embodiment, the center of a surface of the cylindrical small pad 33 is in agreement with the center of a distance between the reading element 321, and the main magnetic pole 311. Tolerances on process sizes for mounting both the reading element 321 and the main magnetic pole 311 in the cylindrical small pad 33 can be increased by causing the center of the cylindrical small pad 33 to coincide with the center of the distance between the reading element 321, and the main magnetic pole 311.

FIG. 2 is a three-dimensional assembly view showing the magnetic head 3 according to the first embodiment of the invention, in the vicinity of a surface thereof, opposite to a medium. A step surface 523 is provided on both sides of the contact surface 423 of the lower shield layer 323 through the intermediary of a step part 333. A step surface 522 is provided on both sides of the contact surface 422 of the upper shield layer 322 through the intermediary of a step part 333. A step surface 515 is provided on both sides of the contact surface 415 of the lower magnetic pole 315 through the intermediary of a step part 333. A step surface 512 is provided on both sides of the contact surface 412 of the shield layer 312 through the intermediary of a step part 333. And a step surface 513 is provided on both sides of the contact surface 413 of the return pole 313 through the intermediary of a step part 333. Further, the respective contact surfaces 423, 422, 415, 412, 413 of the lower shield layer 323, the upper shield layer 322, the lower magnetic pole 315, the shield layer 312, and the return pole 313, as a whole, are substantially circular in shape. In this case, a substantial circle may be not only a true circle but also an ellipse. Then, the respective surfaces of the lower shield layer 323, the upper shield layer 322, the lower magnetic pole 315, the shield layer 312, and the return pole 313, opposite to the disk, as a whole, make up the cylindrical small pad 33.

In the figure, reference character “δs” denotes a step depth of each of the step surfaces 513, 512, 515, 522, 523 from the contact surfaces 413, 412, 415, 422, 423, respectively. Further, a groove 34 is provided between the reader and the writer.

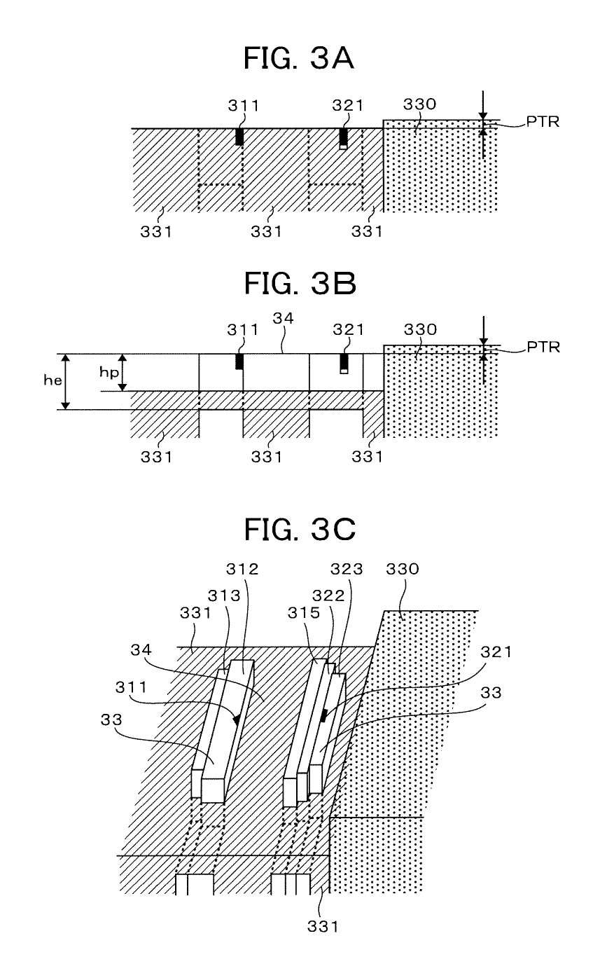

Now, there is described a method for manufacturing the magnetic head slider according to the first embodiment of the invention with reference to FIGS. 3A to 3C.

As shown in FIG. 3A, a nonmagnetic layer 331 made of alumina, and so forth is deposited on an alumina-titanium-carbide substrate 330 in a sputtering system. Subsequently, the lower shield layer 323, the reading element 321, and the upper shield layer 322 for making up the reader 32, and the lower magnetic pole 315 for making up the writer 31 are formed in the sputtering system. Thereafter, a nonmagnetic layer 331 made of alumina, and so forth is deposited in the sputtering system. Subsequently, the main magnetic pole 311, the shield layer 312, and the return pole 313 for making up the writer 31 are formed in the sputtering system. Thereafter, a nonmagnetic layer 331 made of alumina, and so forth is deposited in the sputtering system. As a result, the nonmagnetic layer 331 is found on the respective step surfaces of the lower shield layer 323, the upper shield layer 322, the lower magnetic pole 315, the shield layer 312, and the return pole 313. Then, lapping is applied to the contact surfaces 413, 412, 415, 422, 423, and the surface of the alumina-titanium-carbide substrate 330, respectively. In the figure, “PTR” indicates a step between a nonmagnetic layer made of alumina, and so forth, and the alumina-titanium-carbide substrate.

As shown in FIG. 3B, etching is applied in an ion beam etching system in such a way as to cause the contact surfaces 413, 412, 415, 422, 423 to be rendered cylindrical in shape. By rendering an etching depth “he” smaller than the step depth δs, the respective contact surfaces 413, 412, 415, 422, 423 of the return pole 313, the shield layer 312, the lower magnetic pole 315, the upper shield layer 322, and the lower shield layer 323, as a whole, make up the cylindrical small pad 33. A height “hp” of the cylindrical small pad 33 will coincide with the etching depth he. Subsequently, a slider overcoat 35 made of carbon, and so forth is deposited in the sputtering system.

FIG. 3C is a perspective view of the surface of the magnetic head, opposite to the medium, after application of ion beam etching. The cylindrical small pad 33 including the groove 34 is made up by the respective contact surfaces of the upper shield layer 322, the lower shield layer 323, the lower magnetic pole 315, the shield layer 312, and the return pole 313.

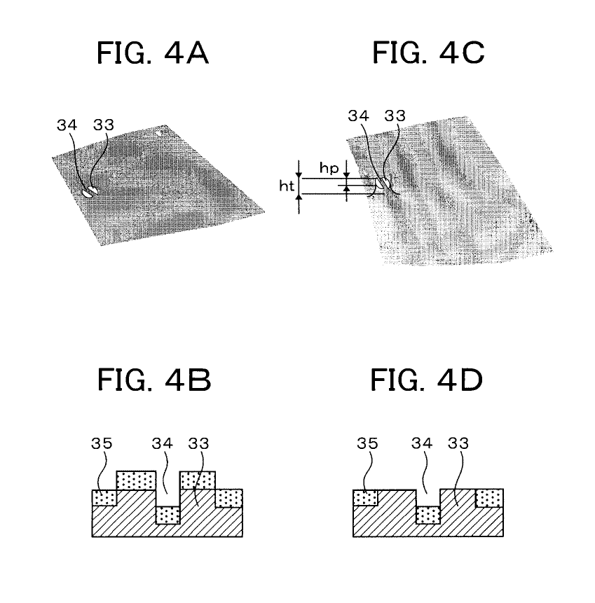

Referring to FIGS. 4A to 4D, there is described hereinafter a method for using the magnetic head slider according to the first embodiment of the invention.

(1) First, the magnetic head slider 1 according to the first embodiment of the invention is mounted on a magnetic disk unit 5. FIGS. 4A, 4B each show the cylindrical small pad 33 provided with the groove 34 therein in the case where no voltage is applied to the heater. The slider overcoat 35 made of, for example, carbon is provided on the surfaces of the cylindrical small pad 33, and so forth, opposite to the medium.
(2) Helium is injected into the magnetic disk unit 5. An object of this operation is to prevent corrosion of the read-write element.
(3) The cylindrical small pad 33 is pushed under a load corresponding to about 2 nm in flying height by applying power to the heater at the time of writing to thereby completely remove the protective overcoat 35 on position of the surface of the cylindrical small pad 33, the position being at the lowest point. FIG. 4C shows a portion of the cylindrical small pad 33, protruded by applying power to the heater, provided with the groove 34, in the vicinity of the read-write element. A protrusion height of the portion of the cylindrical small pad 33, in the vicinity of the read-write element, is indicated by “ht”, and a height of the cylindrical small pad is indicated by “hp”. FIG. 4D shows the cylindrical small pad 33 in a sate where the protective overcoat 35 is completely removed in the case of no power being applied to the heater.

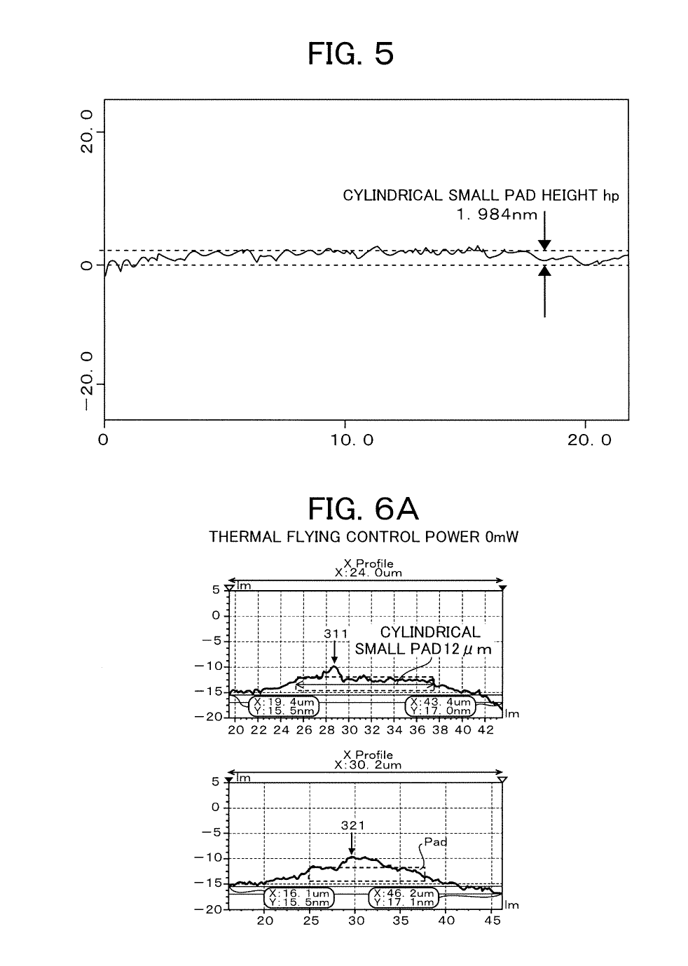

FIG. 5 shows results of shape measurement on the cylindrical small pad when no power is applied to the heater of the magnetic head slider according to the first embodiment of the invention. A measuring instrument that was used is an AFM (Atomic Force Microscope). In the figure, a curve indicates the results of the shape measurement on the cylindrical small pad, a shape passing through the main magnetic pole 311, and it has turned out from FIG. 5 that the height of the cylindrical small pad is 1.984 nm.

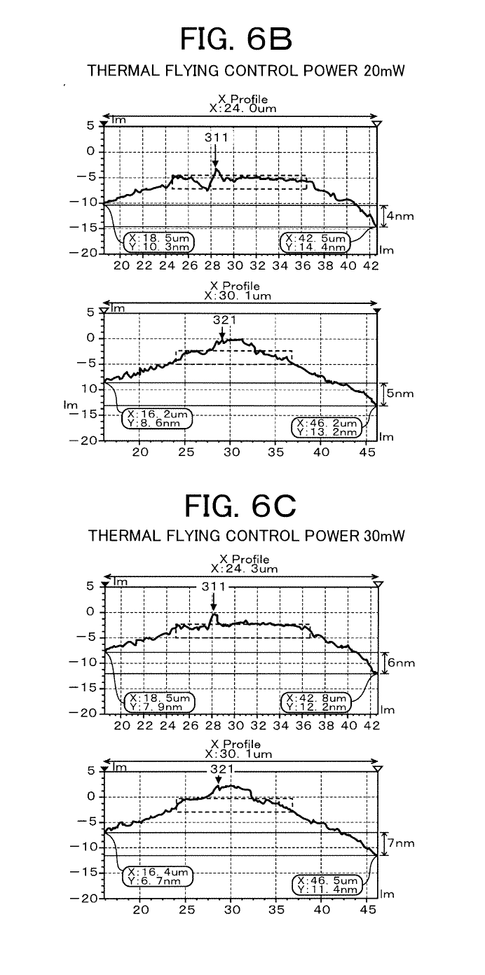

FIGS. 6A to 6C each show results of shape measurement on the cylindrical small pad 33 against varying thermal flying control power of the magnetic head slider according to the first embodiment of the invention. A measuring instrument that was used is a non-contact surface roughness meter. FIG. 6A shows the results of the shape measurement in the case of the thermal flying control power being 0 mV, FIG. 6B shows the same in the case of the thermal flying control power being 20 mV, and FIG. 6C shows the same in the case of the thermal flying control power being 30 mV. Each figure in the upper stage shows the results of the measurement on a portion of the shape, corresponding to the main magnetic pole 311 while each figure in the lower stage shows the results of the measurement on a portion of the shape, corresponding to the reading element 321. In those figures, a portion of the shape, surrounded by a dotted line, indicates the cylindrical small pad. It is apparent from those figures that if the thermal flying control power is applied, this will cause a height of a protruded curved surface, in the vicinity of the read-write element, to increase, and curvature of the protruded curved surface to decrease, however, the height of the cylindrical small pad, and a flat surface of the cylindrical small pad, in the case of the thermal flying control power being 0 mV, hardly change from those in the case of the thermal flying control power being 30 mV. Further, it has turned out that a length of the cylindrical small pad is 12 μm.

In the case where a flying height at reader and writer of the magnetic head slider including the cylindrical small pad, according to the first embodiment of the invention, is set to the same as that of a magnetic head slider without the cylindrical small pad, according to the related art, the flying height at reader and writer of the magnetic head slider according to the first embodiment of the invention is set so as to be smaller by the height “hp” of the cylindrical small pad, however, the thermal flying height power as well will be smaller, and the curvature of the protruded curved surface in the vicinity of the read-write element will be greater. If a curvature radius of the protruded curved surface in the vicinity of the read-write element increases, performance of the slider, for approaching the micro-waviness surface, will deteriorate, thereby causing flying-height variation due to disk surface vibration and waviness to increase. Accordingly, the smaller the height of the cylindrical small pad is, the better in order to inhibit the flying-height variation due to disk surface vibration, and waviness.

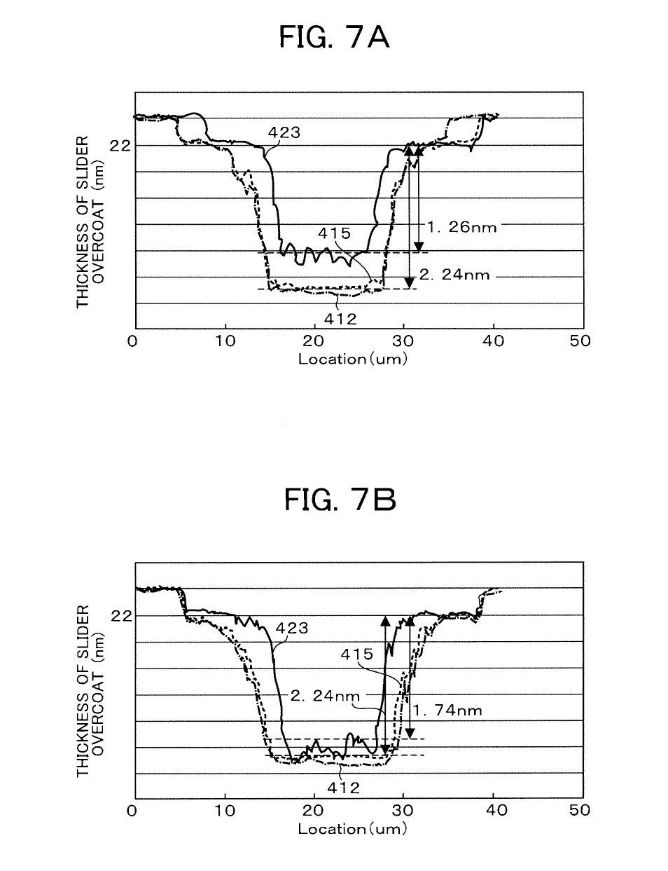

FIGS. 7A, 7B each show results of measuring thickness of wear of the respective protective overcoat of the contact surface 412 of the shield layer, the contact surface 415 of the lower magnetic pole, and the contact surface 423 of the lower shield layer by use of an Auger electron spectroscope after comparing respective Signal/Noise with each other in the case of the cylindrical small pad being pushed under a load corresponding to a flying height 1 nm, and a flying height 2 nm, respectively, using a head 1, and a head 2 of the magnetic head slider according to the first embodiment of the invention are used, while pulling back the cylindrical small pad at a pull-back flying height 2 nm at the time of reading. FIG. 7B shows the case of pushing the cylindrical small pad under the load corresponding to a flying height 2 nm, and FIG. 7A shows the case of pushing the cylindrical small pad under the load corresponding to a flying height 1 nm. The thickness of wear of the protective overcoat of the contact surface 423 of the lower shield layer was found at 1.26 nm, and 1.74 nm against a over-push flying height 1 nm, and a over-push flying height 2 nm, respectively. The thickness of wear of the protective overcoat of the contact surface 415 of the lower magnetic pole as well as the contact surface 412 of the shield layer was found at 2.24 nm against the over-push flying height at both 1 nm, and 2 nm. The reason for this is presumably because if the protective overcoat is completely removed, elastic scattering intensity will decrease, so that the protective overcoat can be seen as if it were left out. However, if the reading element 321 of the lower shield layer wears out, this will cause a charging phenomenon to occur, thereby rendering it harder to observe the protective overcoat, but the results of observation by an SEM show that the charging phenomenon has not occurred, and it is therefore considered that the reading element 321 has hardy worn out.

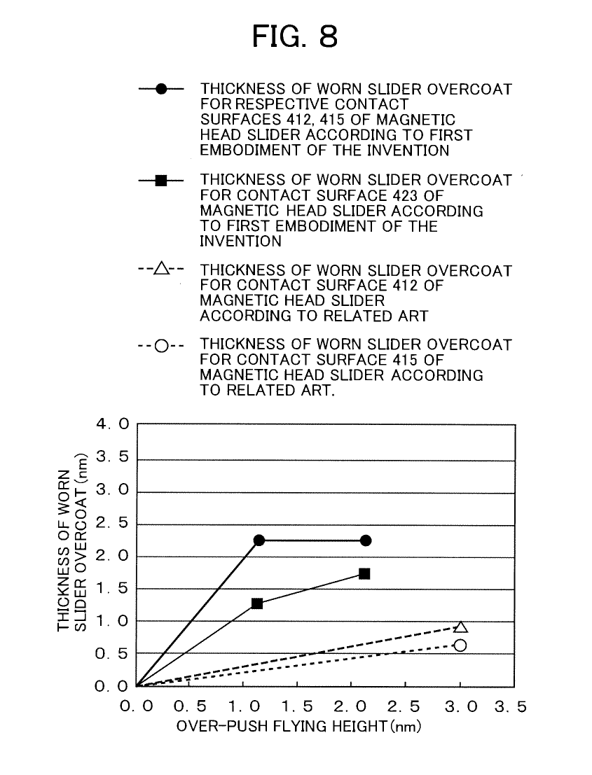

In FIG. 8, there is shown a graph plotted by reorganizing the results of the measurements shown in FIGS. 7A, 7B, respectively, in comparison with results of similar measurements conducted by use of the magnetic head slider according to the related art. In the figure, there is shown a relationship between a over-push flying height, and a thickness of wear of the protective overcoat. It is evident from the figure that, in the case of the magnetic head slider according to the first embodiment of the invention, the protective overcoat can be completely removed at a smaller over-push flying height as compared with the case of the magnetic head slider according to the related art.

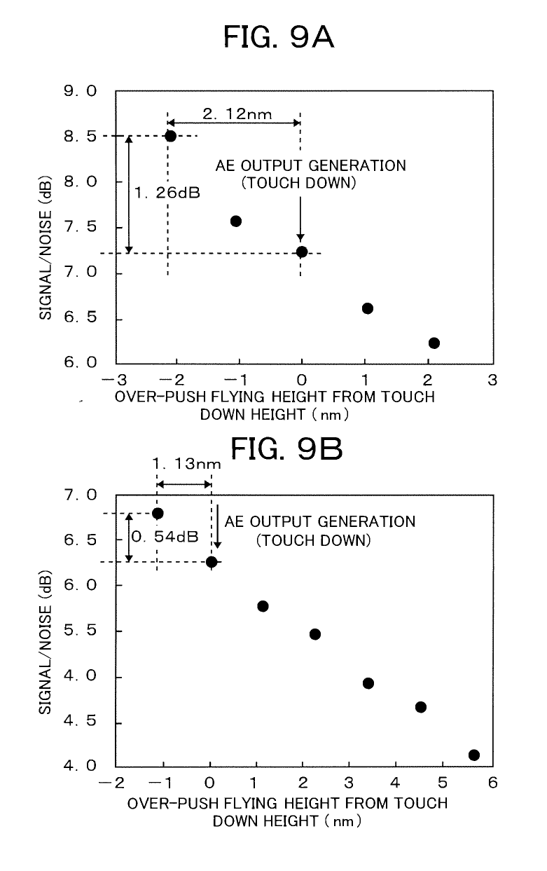

In FIGS. 9A, 9B, respectively, there is shown results of measuring a Signal/Noise when the head 1, and the head 2 of the magnetic head slider according to the first embodiment of the invention are used, and the cylindrical small pad is pushed under the load corresponding to the flying height 1 nm, and the flying height 2 nm, respectively, at the time of writing while pulling back the cylindrical small pad at the pull-back flying height 2 nm at the time of reading. FIG. 9A shows the case of pushing the cylindrical small pad under the load corresponding to the flying height at 2 nm, and FIG. 9B shows the case of pushing the cylindrical small pad under the load corresponding to the flying height at 1 nm. In the case of pushing the cylindrical small pad by 2 nm at the time of writing, as shown in FIG. 9A, the Signal/Noise increased by 1.26 dB. A gain of 1.26 dB corresponds to the effect of reduction in magnetic spacing by 2.12 nm. Such a reduction amount of 2.12 nm, in the magnetic spacing, was substantially in agreement with the thickness of wear 2.24 nm of the protective overcoat of the lower magnetic pole 315 as well as the lower shield layer 323, as shown in FIG. 7A. In the case of pushing the cylindrical small pad by 1 nm at the time of writing, as shown in FIG. 9B, the Signal/Noise increased by 0.54 dB, corresponding to the effect of reduction in magnetic spacing by 1.13 nm. Such a reduction amount of 1.13 nm, in the magnetic spacing, was substantially in agreement with the thickness of wear 1.74 nm of the protective overcoat of the contact surface 415 of the lower magnetic pole 315 as well as the contact surface 423 of the lower shield layer 323, as shown in FIG. 7B. Accordingly, the reason for an increase in the Signal/Noise is presumably because the slider protective overcoat has been completely removed.

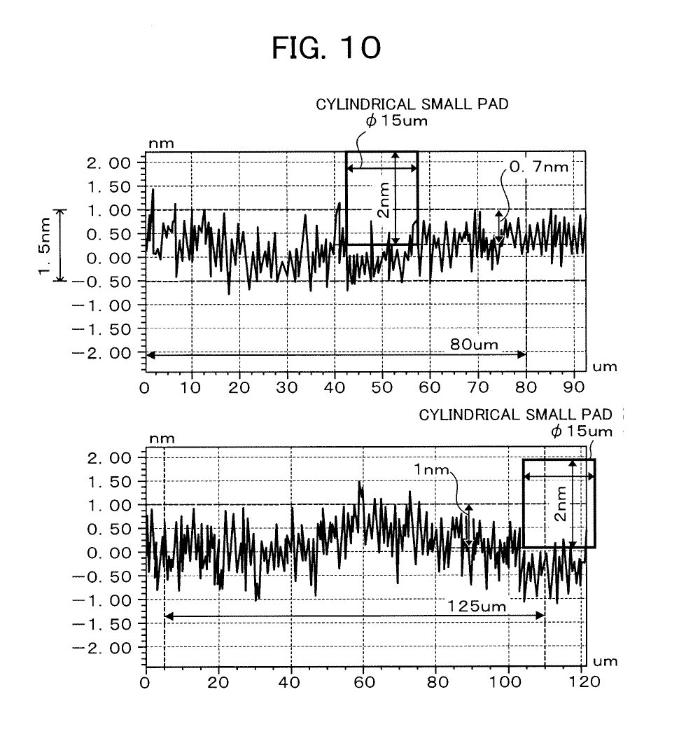

FIG. 10 shows the results of measuring two locations on the surface of a medium used for reading/writing measurement, by use of a non-contact surface roughness meter, at the time when the magnetic head slider according to the first embodiment of the invention is pushed. As micro-waviness on the medium surface is the same as the micro-waviness of magnetic layer, it was found from the figure that a waviness amplitude is in a range of 0.7 to 1 nm against a wavelength of the magnetic film micro-waviness, in a range of 80 to 125 μm. Further, it was also found the figure that in the case where the slider is caused to travel with at least one location of the cylindrical small pad held in a state of contact with the magnetic film micro-waviness in a range of 80 to 125 μm, while a trailing edge and a leading edge of the cylindrical small pad are in turn kept in contact with the magnetic film micro-waviness, a height “hw” of the magnetic film micro-waviness is on the order of from 0.7 to 1 nm, the height hw being a height that can be geometrically followed by the cylindrical small pad 15 μm in diameter, and there exists a region where the cylindrical small pad 15 μm in diameter cannot geometrically approach the magnetic film micro-waviness. This region is a stumbling block for reduction in the touch down flying height, and reduction in the magnetic spacing variation, and it has turned out that it is effective as a method for reducing the size of this region to geometrically miniaturize the area of the cylindrical small pad. Accordingly, in consideration of a distance between the reading element 321 capable of reading/writing, and the main magnetic pole 311, and machining variation, the diameter “hd” of the cylindrical small pad is set to a size larger than 10 μm, and in consideration of an effect of enhancement in performance for approaching the magnetic film micro-waviness, the diameter hd is set to a size smaller than a half-wave length 50 μm of the wavelength from 80 to 125 μm of the magnetic film micro-waviness. Further, the height “hp” of the cylindrical small pad is set to a size larger than the height 0.7 nm of the magnetic film micro-waviness, but smaller than 3.0 nm in order to inhibit the disk surface vibration, and the flying-height variation against waviness.

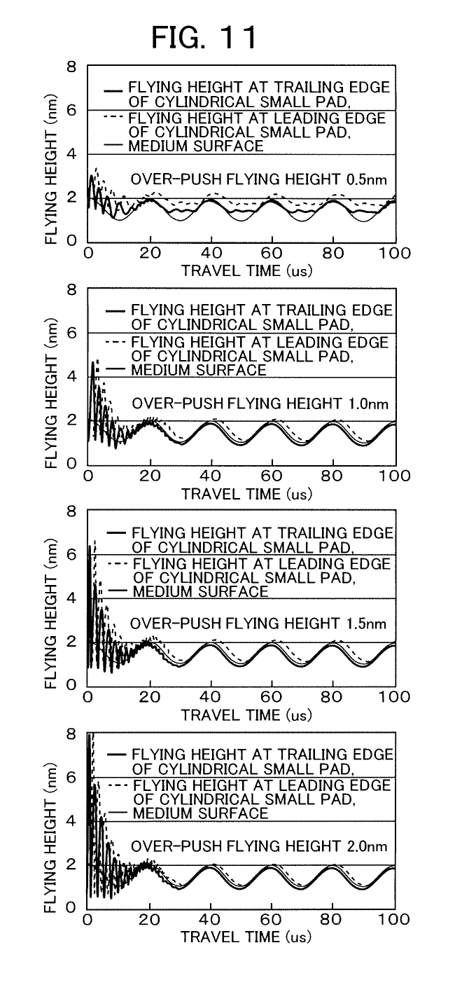

FIG. 11 shows results of calculation on flying height variation over time, at the trailing edge and the leading edge of the cylindrical small pad, respectively, in the case where the push height of the magnetic head slider according to the first embodiment of the invention is varied from 0.5, 1.0, 1.5, and 2.0 nm, respectively. It is assumed that the diameter of the cylindrical small pad is 15 μm, and peripheral speed thereof is 10 m/s. In the figure, a sine wave indicates a magnetic film micro-waviness surface having a wavelength at 0.2 mm, frequency at 50 kHz, and amplitude 2 nm.

As is evident from FIG. 11, when the push height is as small as 0.5 nm, moment is always acting on the surface of the cylindrical small pad by the agency of a contact force, and a frictional force, so that the cylindrical small pad is susceptible to be away from the magnetic film micro-waviness due to a pitching motion, however, when the push flying height is increased to 1.0, 1.5, and 2.0 nm, respectively, it is found that the cylindrical small pad keeps contact and follow-up travelling with at least a portion of the cylindrical small pad, held a state of contact with the magnetic film micro-waviness, while the trailing edge of the cylindrical small pad, and the leading edge thereof are, in turn, kept in contact with the magnetic film micro-waviness. The trailing edge of the cylindrical small pad, in particular, travels while being held in a state of contact with the magnetic film micro-waviness, so that wear at the trailing edge of the cylindrical small pad becomes greater, which is considered to have caused the thickness of worn protective overcoat of the shield layer 312, and the thickness of worn protective overcoat of the lower magnetic pole 315 to be greater as compared with that for the lower shield layer 323.

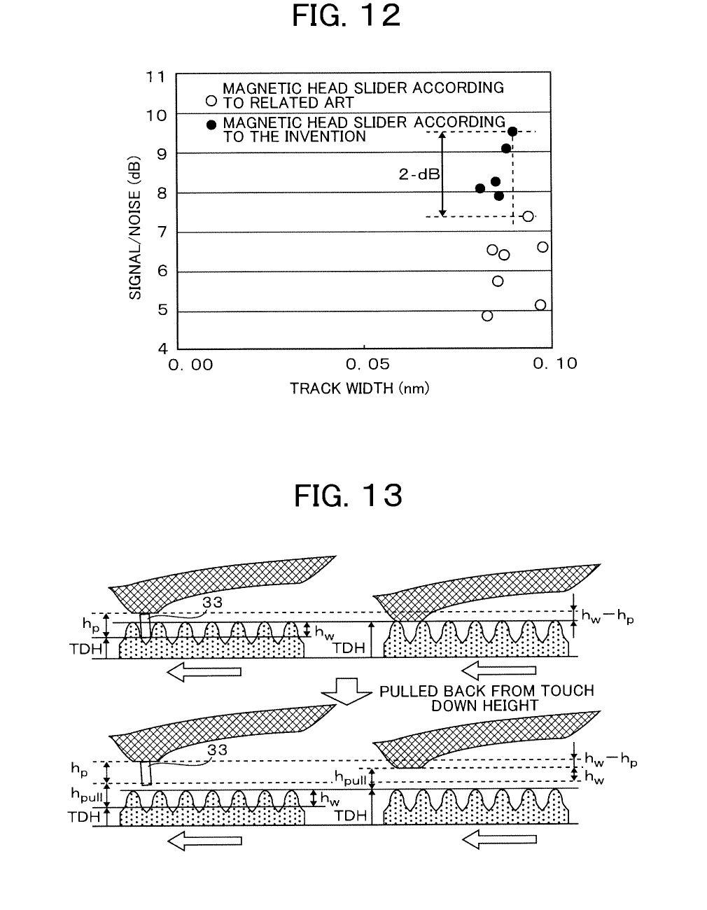

FIG. 12 shows results of measuring respective Signal/Noise as measured when the magnetic head slider is pulled back with the pull-back flying height at 3.4 nm at the time of writing, while being read with the pull-back flying height at 2.4 nm at the time of reading, in the case of the magnetic head slider including the cylindrical small pad, according to the first embodiment of the invention, and in the case of the magnetic head slider without the cylindrical small pad, according to the related art, respectively. For a measuring instrument, use was made of RH4160 manufactured by Hitachi High Technologies Co. Ltd. As is evident from the figure, the Signal/Noise of the magnetic head slider according to the first embodiment of the invention is higher by 1 to 2 dB as compared with the case of the magnetic head slider according to the related art. In consequence, if the pull-back flying height at the time of writing, and the pull-back flying height at the time of reading in the case of the magnetic head slider including the cylindrical small pad, according to the first embodiment of the invention, are the same as those in the case of the magnetic head slider without the cylindrical small pad, according to the related art, the touch down height of the magnetic head slider according to the first embodiment of the invention is smaller as compared with the magnetic head slider according to the related art, so that it was possible to confirm an advantageous effect of reduction in the touch down height, and an advantageous effect of reduction in the magnetic spacing in the case of the magnetic head slider according to the first embodiment of the invention.

FIG. 13 is a side view showing the magnetic head slider according to the first embodiment of the invention (on the left side in the figure) and the magnetic head slider according to the related art (on the right side in the figure), at the time of measuring the touch down height, respectively. Referring to FIG. 13, there is described hereinafter the reason why the Signal/Noise of the magnetic head slider according to the first embodiment of the invention becomes higher as compared with the case of the magnetic head slider according to the related art, and the effect of reduction in the touch down height of the cylindrical small pad. When power is applied to the heater mounted in the vicinity of the read-write element, the air bearing surface in the vicinity of the element is caused to protrude, and the flying height of the read-write element position is lowered, thereby causing the portion of the slider, at the lowermost point, to come into contact with the micro-waviness, the curvature radius of the protruded curved surface in the vicinity of the read-write element of the magnetic head slider according to the related art is greater than the curvature radius of the micro-waviness surface, so that there exists a region where the protruded surface of the slider, in the vicinity of the read-write element, does not come into contact with a portion of the micro-waviness surface, at the bottom thereof, thereby preventing the protruded surface from geometrically approaching the micro-waviness. In the case of the magnetic head slider according to the first embodiment of the invention, the diameter hd of the cylindrical small pad is set to a size smaller than a half-wave length 50 μm of the wavelength from 80 to 125μm of the magnetic film micro-waviness, and the height “hp” of the cylindrical small pad is set to a size larger than the height “hw” of the magnetic film micro-waviness, which is considered the reasons why the region where the protruded surface cannot geometrically approaches the micro-waviness becomes smaller in size.

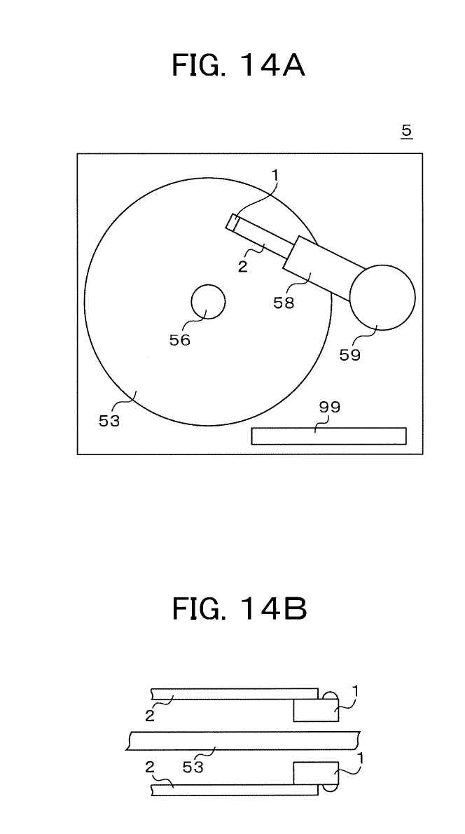

FIGS. 14 A, 14B each show an embodiment of the magnetic disk unit 5 using the magnetic head slider according to the first embodiment of the invention. FIG. 14 A is a plan view of the magnetic disk unit 5 at the time when the magnetic head slider 1 according to the first embodiment of the invention is travelling, and seeking in a state of flying over a magnetic recording medium 53, and FIG. 14B is a side view of the magnetic disk unit 5. The magnetic disk unit 5 is composed of the magnetic recording medium 53, a driver 56 for rotating the same, the magnetic head slider 1 according to the first embodiment of the invention, supports 2 of the same, a support arm 58 for positioning, a driving unit 59 of the same, and a circuit 99 for processing a read-write signal of the magnetic head 3 mounted on the magnetic head slider 1 according to the first embodiment of the invention.

What is claimed is:

1. A magnetic head slider comprising:
a reader composed of an upper shield layer, a lower shield layer, and a reading element provided between the upper shield layer and the lower shield layer;
a writer composed of a lower magnetic pole, a main magnetic pole, a shield layer, and a return pole; and
a heater for generating heat when power is applied thereto,
wherein a contact surface coming into contact with a medium surface when power is applied to the heater, and a step surface formed on both sides of the contact surface, through the intermediary of a step part, are provided on respective surfaces of the upper shield layer, the lower shield layer, the lower magnetic pole, the shield layer, and the return pole, the respective surfaces being opposite to a disk, and the respective contact surfaces of the upper shield layer, the lower shield layer, the lower magnetic pole, the shield layer, and the return are configured so as to be substantially circular in shape, as a whole, thereby providing a cylindrical small pad on a surface of a magnetic head slider, opposite to the disk.

2. The magnetic head slider according to claim 1, wherein the center of the cylindrical small pad is caused to coincide with the center of a distance between the reading element, and the main magnetic pole.

3. The magnetic head slider according to claim 1, wherein a groove is provided between the reader and the writer, in the cylindrical small pad.

4. The magnetic head slider according to claim 1, wherein hp is in a range satisfying a condition of 0.7 nm≦hp≦3.0 nm where hp is a height of the cylindrical small pad.

5. The magnetic head slider according to claim 1, wherein hd is in a range satisfying a condition of 10 μm≦hd≦50 μm where hd is a diameter of the cylindrical small pad.

6. The magnetic head slider according to claim 1, wherein a slider protective overcoat on a surface of the cylindrical small pad is removed by applying power to the heater.

7. The magnetic head slider according to claim 1, wherein an etching depth due to etching applied in an ion beam etching system is rendered smaller than a depth of a step between the contact surface and the step surface.

8. A magnetic disk unit wherein the magnetic head slider according to claim 1 is mounted.
